(19) United States
(12) Patent Application Publication
(10) Pub. No.: US 2014/0101426 A1
(43) Pub. Date: Apr. 10, 2014

(54) PORTABLE, SECURE ENTERPRISE PLATFORMS

(71) Applicant: MSI SECURITY, LTD., McLean, VA (US)

(72) Inventor: Janarthanan Senthurpandi, McLean, VA (US)

(73) Assignee: MSI Security, Ltd., McLean, VA (US)

(21) Appl. No.: 13/661,835

(22) Filed: Oct. 26, 2012

Related U.S. Application Data
(63) Continuation-in-part of application No. 13/645,479, filed on Oct. 4, 2012.

(51) Int. Cl. G06F 21/00; G06F 15/177

(52) U.S. Cl. 713/2; 713/1

(57) ABSTRACT

A portable, secure enterprise computing platform is provided by a device having a storage or memory, including a firmware module, a processor and an interface for interfacing with a host platform. The interface may be a USB interface and the device may have the form factor of a USB thumb drive. The storage may include a public partition, secure partition, operating system partition and command partition. A boot load manager in the firmware module causes the processor to load an operating system on the operating system partition and selectively enables access to the operating system by the host platform. The operating system partition may be formatted as a CDFS device such that the host platform recognizes the device as a bootable CD drive. The device provides for secure booting to the operating system partition by the host platform, without risk of corruption or malware from the host platform. A user may select from multiple operating systems. Multiple devices may be managed by a policy management application, which may assign groups of users and applications to one or more devices across an enterprise.

### CROSS-REFERENCE TO RELATED APPLICATIONS

The present application is related to co-pending U.S. patent application Ser. No. 13/645,479 titled REAL IDENTITY AUTHENTICATION, filed on Oct. 4, 2012, the subject matter of which is incorporated herein in its entirety.

### BACKGROUND

1. Technical Field

The disclosure relates generally to the field of computing platforms, computer operating systems and information security. More specifically, the disclosure relates to devices, processes and systems for establishing portable, secure enterprise computing platforms and operating systems, and devices, processes and systems for managing a number of portable, secure enterprise platforms and operating systems across an enterprise.

2. Background

Computing platforms typically include a hardware architecture combined with a software framework, including an operating system and applications. This combination provides an environment that supports user execution of software applications and access to processing and storage resources. Typical platforms include a computer's architecture, operating system, programming languages and related user interfaces, such as run-time libraries or graphical user interfaces.

Operating systems form the basic instructional foundation for computers to manage processing and memory resources, and to interface with input and output devices and applications. Before a computer can fully exploit the functionality of an operating system, the operating system must be loaded into memory and executed through a boot process. Computers typically include a Basic Input Output System (BIOS), which may reside in firmware or software, and which facilitates the basic input and output operations necessary to accomplish the booting of the computer. The BIOS may perform the steps of identifying bootable external devices, such as mechanical disk drives or solid-state mass storage devices, such as a USB thumb drive, and loading boot instructions from a predetermined location, sometimes termed a master boot record, on the external device into the computer memory. In some BIOS implementations, an implicitly trusted BIOS boot block is the first firmware to load and may typically check the integrity of the remaining BIOS. The trusted boot block may load a primary BIOS into memory and then check its integrity. The BIOS may typically initialize a processor and memory as well as peripheral devices including a boot device from which a boot loader may be loaded into memory and executed in order to facilitate loading of the operating system into memory.

In order to mitigate security risks in typical enterprise computing environments, and to provide portability for operating systems, there have been attempts in the prior art to provide secure operating systems on bootable external devices, such as bootable USB mass storage devices that interface with a host platform. The secure operating system may be a proprietary or modified operating system with enhanced security features. Such prior art systems are exemplified by a product known as “Secure Workspace” by Imation Corporation, of Oakdale, Minnesota, and others who are in the similar space of operating system portability. Such devices may permit users to boot a Windows desktop from a secure, portable USB thumb drive and transform a host computing platform into a trusted IT-managed workstation, to provide enterprise workers with portability and security with regard to their data, applications and systems. Known prior art systems with portable operating systems also suffer from the drawback of being exposed to security risks that may be present on a host operating system. For example, with prior art devices, even though a host platform may be booted to a so-called “secure” operating system on the portable device, the host platform operating system continues to execute in parallel. As a result, resources on the host platform, such as corrupt files or malware applications on the host system hard drive, may still cause unauthorized and undetected access to, and compromise the integrity of, the “secure” operating system on the device. Such prior art systems, therefore, do not provide a completely secure computing environment.

Other devices sometimes referred to as “pocket desktops” have been provided in the form of bootable USB thumb drives with their own secure operating systems. However, such systems do not provide flexibility because the operating system is typically pre-loaded and pre-configured and not capable of being readily modified by the user. Moreover, such systems utilize a software-based operating system on the portable device, which is vulnerable to security risks. Additionally, such systems do not provide for secure, biometric, real identity authentication of the user. Still further, such systems do not permit the user to select from among multiple secure operating systems or provide enterprises with the flexibility to securely manage computing platforms for groups of users or groups of devices. Finally, such systems do not combine capabilities for secure authentication and platform management, including operating system and application management, in a manner that permits such devices to be readily adopted and managed broadly across an enterprise.

Prior art devices such as those described above are susceptible to other security risks. The secure operating system files are typically stored on a publicly accessible partition of prior art portable operating system devices, rendering those files visible and susceptible to deletion, modification and/or corruption. Since such files are visible, they are exposed to security risks, and any of the above-described actions by malware could corrupt the operating system and prevent booting from the device. Additionally, unauthorized users are able to readily view, manipulate and corrupt such publicly accessible files.

Another drawback of prior art portable devices is that they do not offer “plug and play” operation. Such devices require a change to the BIOS settings of the host computer and/or the boot priority of devices connected to of the host computer. Such devices typically utilize an operating system loader, which is implemented as a software application on a public partition on the device and which controls the shutdown and the rebooting processes of the host computer. Because such prior art devices utilize a software-based loader that must be loaded to the host system each time the operating system is established, they are susceptible to security risks since the software-based loader could be modified or the boot loader file to which the software directs the host computer could be mimicked to allow unsecure access.

Still further, such prior art devices are typically dependent on a proprietary operating system that resides on and is integrated with the device. Such devices do not provide an enterprise with the flexibility to load their own individual operating system or to use a standard commercial (i.e., Windows®) or open source operating systems as the enterprise operating system. Additionally, such prior art devices only have the ability to load a single operating system. Further, such devices do not provide the user with the flexibility to easily choose from a number of operating systems. Finally, such prior art devices may typically leave data on the host computer system related to the use or work session of the operating system, adding to the security risks. There is thus a need in the art for devices, processes and systems that address the aforementioned and other shortcomings in the prior art.

Still further, prior art devices do not provide an enterprise with flexibility in terms of managing groups of devices, their operating systems and security access, across an enterprise. For example, if a device is lost or stolen, prior art systems do not permit an enterprise to modify the security access features of the lost or stolen device.

Prior art devices also allow the users to cold boot an operating system from the device. In this case, the cold boot is enabled by the primary boot drive (i.e., hard drive) being disabled or removed from the system or the bios being modified to initially boot from an external device. The cold boot loads the operating system from an external device, which may or may not function as a secured operating system. Prior art devices may use a common authentication methodology of user-id and password or have no authentication processes that control cold booting directly into the operating system.

### SUMMARY OF THE INVENTION

Aspects of the invention provide devices, processes and systems that establish a secure portable enterprise computing platform. The device may interface with a host computing platform through a standard USB interface or a wireless interface. The device includes firmware-and/or hardware- based boot loader application that dynamically activates an operating system partition as a boot partition, based on authentication from the user, such that the operating system partition may be selectively presented to the host computer as a bootable device without modification to the host computer native operating system BIOS.

Aspects of the invention also provide a portable enterprise boot device that includes a USB interface, biometric authentication capability and a storage having a public partition, command partition, an operating system partition and a secure partition. Multiple operating systems may be provided on the operating system partition. An enterprise operating system management application may be executed on the host platform and may selectively enable or disable each of the public partition and operating system partition. The operating system partition emulates a default host platform boot device. An enterprise operating system management application may be executed on the host platform to enable configuration of the boot management module and to install one or more operating systems on the operating system partition.

In one example, the default boot device on the host platform may be a Compact Disk File System (CDFS)-compatible file device, such as a disk drive that supports removable CD-ROM or DVD media. In this example, the boot management module modifies the secure partition to emulate a CDFS formatted drive. The boot management device further disables the public partition. When the host platform is rebooted, the user is prompted to ensure that no media is present in the host default boot device. When rebooted, the host platform then boots the enterprise operating system from the secure partition on the device.

According to another aspect of the invention, the portable enterprise boot device includes a boot management module and an authentication module, which are provided in firmware or other storage, which has restricted access, i.e., access by a user with administrative rights. This aspect prevents unauthorized access to the enterprise OS partition and operating system, thereby enhancing security.

Also according to an aspect of the invention, the enterprise operating system files are not publicly accessible because they are stored in a secured partition and only visible and accessible by user who has been biometrically authenticated on the device. This prevents unauthorized access to and accidental modification, deletion or corruption of the source files of the enterprise operating system.

Another aspect of the invention allows the user to choose from a selection of different operating systems. An operating system management application may be executed on the host platform and may present an inventory of operating systems stored on the secure boot device. A user may select one of the operating systems and, as a result, the operating system management application loads the selected operating system into the operating system partition of the secure boot device. Upon reboot, the selected operating system is loaded to the host platform.

Additionally, through role-based access controls and user permissions, the invention provides a portable enterprise operating system device in which groups of devices can be configured and managed across an enterprise. The configuration, including available applications and operating systems, of each device assigned to a worker in an enterprise can be managed centrally by an enterprise administrator. Device access to the enterprise operating system may be managed through enterprise control and/or local offline access enabled on the device. This approach to access and use of the enterprise operating system device provides multi-layer security controls, which may include role-based controls, user account permissions, authentication processes including biometrics, mitigates security risks for unauthorized use, for example, should the device be misplaced, stolen or lost.

The invention provides a “cold boot” that enables the device processes to perform the authentication processes prior to the enterprise OS booting process. The device will trigger the authentication request and then the user performs biometric authentication prior to loading the operating system.

### BRIEF DESCRIPTION OF THE DRAWINGS

The features and attendant advantages of the invention will be apparent from the following detailed description together with the accompanying drawings, in which like reference numerals represent like elements throughout. It will be understood that the description and embodiments are intended as illustrative examples and are not intended to be limiting to the scope of invention, which is set forth in the claims appended hereto.

FIG. 1 illustrates network environment suitable for supporting a portable secure boot device according to an aspect of the invention.

FIG. 2 is a block diagram showing components of an exemplary host platform suitable for use with a USB device according to an aspect of the invention.

FIG. 3 is a schematic block diagram illustrating components of a USB device according to an aspect of the invention.

FIG. 4 is a process flow showing steps for establishing a portable secure enterprise operating system according to an aspect of the invention.

FIG. 5 is a process flow showing steps in a process for selecting from among multiple operating systems on a portable enterprise operating system device according to an aspect of the invention.

FIG. 6 illustrates another exemplary network environment suitable for supporting one or more secure, portable enterprise platform devices, methods and systems according to an aspect of the invention.

FIG. 7 illustrates a user interface display for enabling user access to an administrative portal functionality.

FIG. 8 illustrates a user interface display for enabling user access to an application management functionality.

FIG. 9 illustrates a user interface display for enabling user access to functionality for adding an application, according to an aspect of the invention.

FIG. 10 illustrates a user interface display for enabling user access to functionality for assigning an application to a group, according to an aspect of the invention.

FIG. 11 illustrates a user interface display for enabling user access to functionality for assigning managing a group of users, according to an aspect of the invention.

FIG. 12 illustrates a user interface display for enabling user access to functionality for assigning an application to a device according to an aspect of the invention.

### DETAILED DESCRIPTION

It will be understood, and appreciated by persons skilled in the art, that one or more processes, sub-processes, or process steps described in connection with the Figures included herewith may be performed by hardware, firmware and/or software. If the process is performed by software or firmware, the software or firmware may reside in software or firmware memory in a suitable electronic processing component or system such as one or more of the functional components or modules schematically depicted in the Figures. The software in software memory may include an ordered listing of executable instructions for implementing logical functions (that is, “logic” that may be implemented either in digital form such as digital circuitry or source code or in analog form such as analog circuitry or an analog source such as analog electrical, sound or video signal), and may selectively be embodied in any computer-readable medium for use by, or in connection with, an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by, or in connection with, the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic), and a portable compact disc read-only memory “CDROM” (optical).

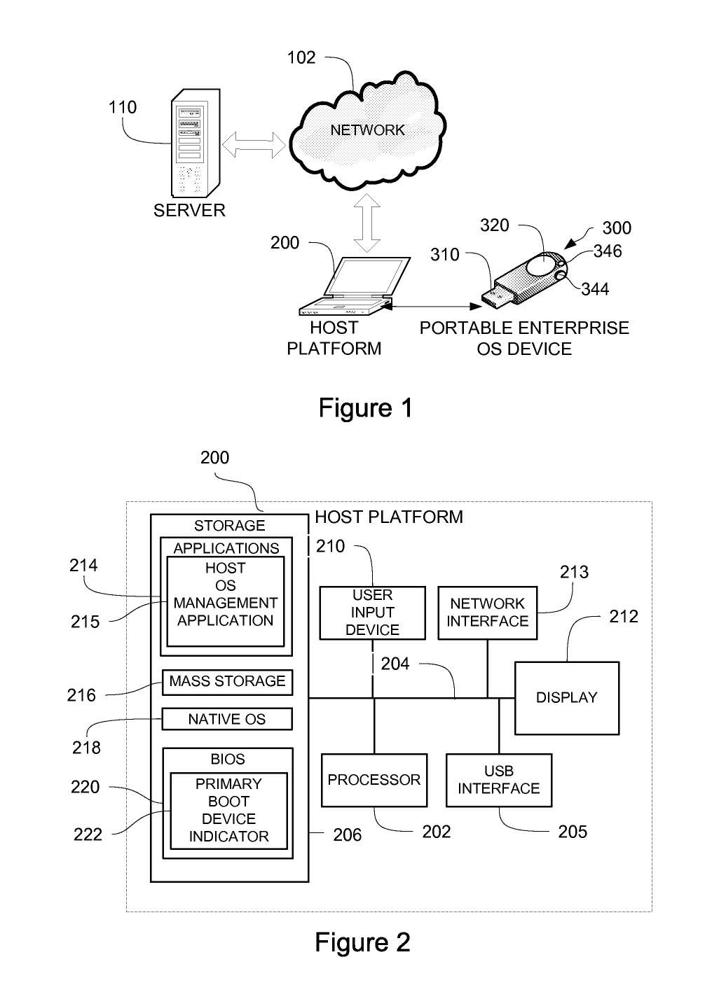

FIG. 1 illustrates a network environment suitable for supporting a portable secure device 300 for establishing an enterprise operating system according to an aspect of the invention in a network environment. A host platform 200, which may be a laptop computer, mobile device or other computing platform, acting as a client to a remote server 110 via a wide area network (WAN) 102. In accordance with an aspect of the invention, a device 300 for establishing a enterprise operating system may interface via universal serial bus (USB) interface 310 with the host platform 200, and may include an authentication device in the form of a biometric input device 320, which may be a fingerprint recognition device.

It will be understood by those of ordinary skill that devices embodying aspects of the invention may operate with different host platform configurations. For example, some host platforms may not include all of the elements exemplified in FIG. 1, but may include subsets of the components depicted therein. The invention is contemplated to be coupled to a host platform that may be a very “thin” computing platform, including only a power supply, display, input device, network interface and device (USB) interface, or only components necessary to interface with the device and with a network.

FIG. 2 is a block diagram showing components of a host platform 200 suitable for use with a portable enterprise operating system device 300 (FIG. 1), according to an aspect of the invention. Although a USB interface is illustrated between the device 300 and the host platform 200, other implementations for communicatively coupling the device 300 to a host platform 200 are contemplated, including wireless technologies, such as Bluetooth® or wireless network technologies, such as Wi-Fi. A processor 202 communicates via an electronic data bus 204 with a storage 206, display 212, device user interface 210, portable enterprise operating system device interface 205, which may be a USB interface, and network interface 213. Processor 202 may execute instructions representing applications 214 in storage 206. Storage 206 also contains a mass storage section 216 for storing data and instructions as well as a native operating system 218 and a Basic Input Output System (BIOS) 220. The BIOS 220 may include a configuration file, which directs the BIOS to boot to a primary boot device, which may be an optical drive, 222 capable of reading CD-ROM or DVD-ROM media.

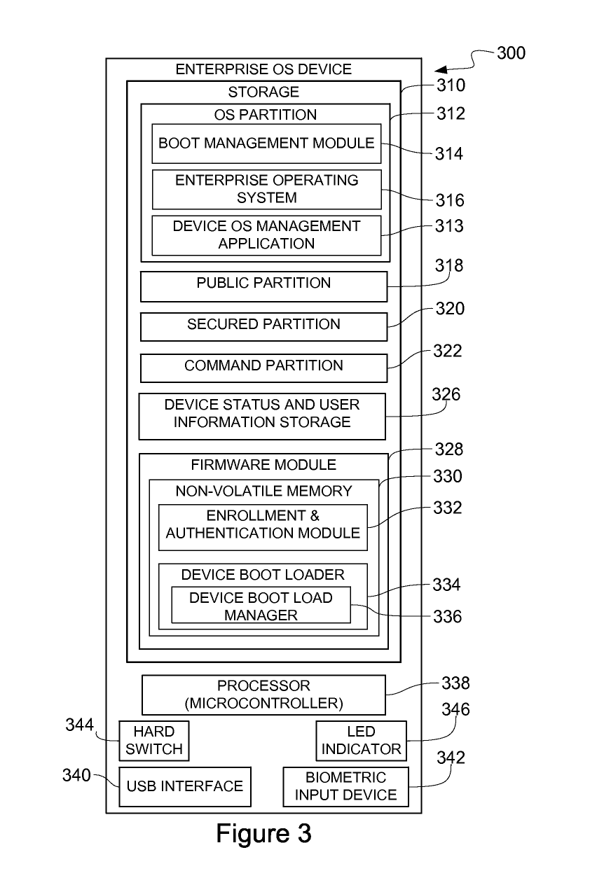

FIG. 3 illustrates a schematic block diagram of a portable enterprise operating system device according to the aspect of the invention. The enterprise operating system device includes a storage 310, processor 338, which may be a microcontroller, biometric input device 342 for sensing biometric information that is input by a user, and a USB interface 340 for interfacing with a host platform. As in the case of the host platform, a data bus (not shown) may provide communication between processor 338, storage 310, interface 340 and other components. Storage 310 may be logically organized into partitions including an operating system (OS) partition 312, public partition 318, secured partition 320 and command partition 322. According to an aspect of the invention, the OS partition 312, may be a CDFS format logical partition and may include a boot management module 314 and one or more enterprise operating systems 316. OS partition 312 also includes a device OS management application 313, the function of which will be described below.

A device status and user information storage 326, which may be a flash type memory, may store user information's like username, password and applications assigned to the user. A firmware module 328 provides a secure environment which may not be written to or modified without particular administrative rights and interfaces, consists of a non-volatile memory 330 which is used to store core programs of the device, such as an enrollment and authentication module 332 and a device boot loader 334. The enrollment and authentication module 332 may enroll, encrypt, decrypt and compare user's fingerprint during enrollment and authentication process. The device boot loader 334 loads the firmware to the device.

According to an aspect of the invention, the public partition and the OS partition are organized according to a CDFS format, access to which may only be obtained via the device firmware, which prevents any undesired or unauthorized action or deletion of the files present in those partitions. The CDFS device is created by the device boot loader 334 and device boot load manager in firmware module 328. An administrator may configure the device remotely to download, during a next communication or update session, an .iso image of a desired operating system. The .iso image may be stored on both the public and OS partitions. The .iso file image on the public partition may include software application files particular to a user or device. The .iso image file on the OS partition may include secured operating system source files.

During an initial configuration session, a host OS management application 215 may be executed on the host system and permit a user to select an option where the device is chosen as a bootable device. The command partition 322 receives and may decrypt commands from the host OS management application 215. The command partition 322 also provides commands to the firmware module 328. In this manner, security of the firmware module is enhanced. According to an aspect of the invention, operations such as switching active partitions, user enrollment, authentication, and storage of sensitive device and user information takes place via commands, which may be encrypted, issued to the command partition, which may hidden files that are not accessible to unauthorized users.

According to an aspect of the invention, the command partition provides a command channel for the firmware module 328. This eliminates the need for installing applications on the host platform. Commands received by the command partition trigger operations within the firmware module 328, which actively monitors the command partition for the presence of instructions or commands, which may be encrypted.

According to an aspect of the invention, the command partition provides functions during the boot sequence. In this manner, the need for executing applications on the host platform is eliminated. Rather, the firmware module on the device supports all operations and executes all applications within a secure environment on the device.

According to an aspect of the invention, an external hard switch 344 (FIGS. 1 and 3) may be provided to lock and unlock the secure partition. When the switch is pressed, the device requests authentication from an administrator. The level of access rights for an administrator will be higher than those for a typical user. After the administrator successfully authenticates with biometric information, the secure partition will be unlocked. External hard switch 344 may be used to support cold booting of a secure operating system from the portable enterprise platform. Specifically, when the device is inserted into the USB port of the host system, upon power up, the hard switch may be activated to allow the user to indicate that booting should occur from the device. If the hard switch is activated, the device will prompt the user, by flashing the LED indicator 346 (FIGS. 1 and 3), to input biometric data, such as a fingerprint scan. Following successful authentication, which may occur according to the real identity authentication process disclosed in related application Ser. No. 13/645,479, the secured partition is unlocked and the host platform may be booted from the operating system that resides on the OS partition.

When the portable enterprise platform device is connected to a host platform for the first time, the flag status in NOR flash is set as 0 (zero) and, as such, only the public partition and command partition are active (accessible). The command partition is active in all four of the states, since the command partition must receive commands from the host enterprise operating system application 218 (FIG. 2). When the enterprise operating system application is executed, the application sends commands to the portable enterprise platform device to unlock the operating system (OS) partition (LUN 0). This is accomplished by the command partition in device firmware receiving a command to set the flag status to a value of “2” where all but the public partition (LUN 1) are active. The secure partition (LUN 2) remains in an inactive state since that partition is preferably not utilized during the operating system booting sequence. If a user desires access to the secure partition, an administrative authentication sequence is required.

According to an aspect of the invention, the OS partition 312, public partition 318, secure partition 320 and command partition 322 may be assigned logical unit numbers (LUN's) in the device firmware. In addition, the overall status of the respective partitions may be represented by setting a flag value in NOR flash and is described in flag status table as depicted below in Table 1. The flag status table may be stored in flash memory in the firmware module 328 in the boot load manager 336 (FIG. 3). The device boot manager 336 performs operations for activating or disabling partitions on the device. Commands may be issued by the firmware module 328 to change the boot load manager status and the status of the partitions.

TABLE 1

| Flag status | 0 | 1 | 2 | 3 |
|---|---|---|---|---|
| OS Partition (LUN 0) | Inactive | Inactive | Active | Inactive |
| Public Partition (LUN 1) | Active | Active | Inactive | Active |
| Secure Partition (LUN 2) | Inactive | Inactive | Active | Active |
| Command Partition (LUN 3) | Active | Active | Active | Active |

When a secure portable enterprise platform device according to an aspect of the invention is first interfaced with a host platform, the status of the partitions (active/inactive) can be known with the help of setting a flag status in NOR flash. for example, by reading the contents of an address in firmware flash memory. A flag status of “2” in NOR flash signifies that the secure partition is active, so the device initiates an authentication process for an administrator to confirm that the secure drive should be open. If no administrator authentication is done, the device firmware sets the flag status to “1” and thereby locks the secure partition and OS partition and leaves only the public and command partitions active.

Next, the firmware determines the current format of the device public partition, i.e., whether or not the public partition is a FAT file system or CDFS file system. If the public partition is detected as a FAT format file system, the firmware initiates reformatting of the public partition to a CDFS file system. This may be done by copying an .iso image to the public partition.

Next, the firmware must recognize the public partition as a CDFS file format device. This may be done by appropriate firmware commands for mounting the public partition as a CDFS device. The firmware also determines the location (sector) of the master boot record (MBR) on the public partition CDFS device. This location is passed to the host platform to support booting of the device CDFS partition.

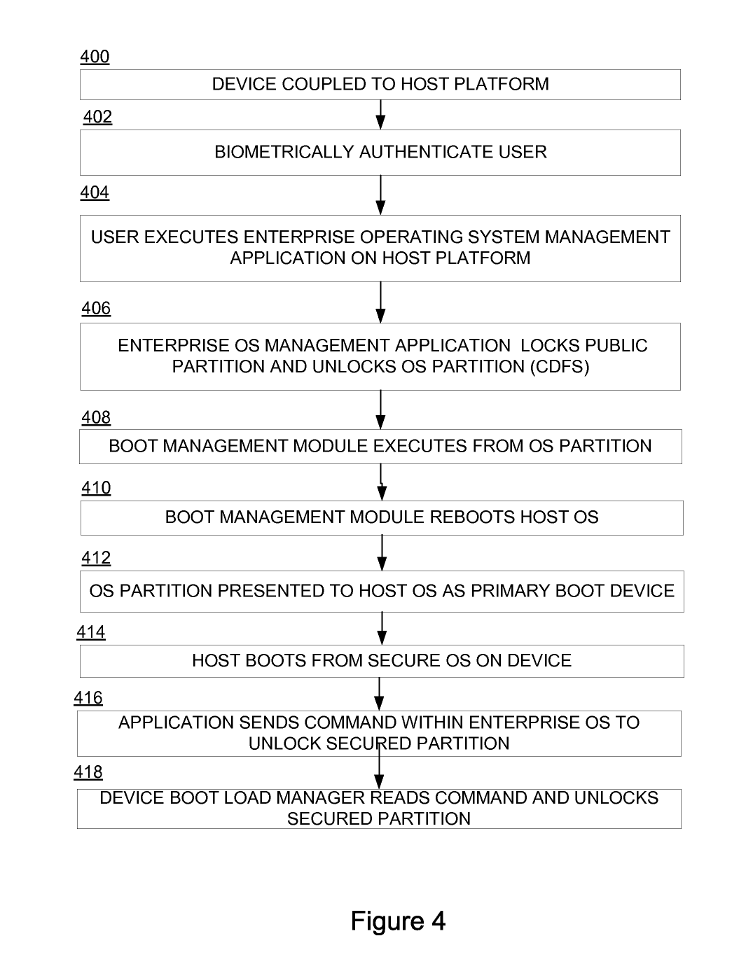

FIG. 4 illustrates exemplary process steps performed with regard to a secure boot device according to an aspect of the invention. At step 400, the device is coupled to a host platform, such as through the USB interface described above. At step 402, a user biometrically authenticates through the biometric input device 342 (FIG. 3) and authentication module 332. The authentication aspects of the device may include inventions described in related patent application Serial No: 13/645,479, the subject matter of which is incorporated herewith, in its entirety.

At step 404, user executes the enterprise operating system management application 215 (FIG. 2) on the host platform 200. At step 406, the enterprise operating system management application 215 locks the public partition 318 and unlocks the OS partition 312. At step 408, the boot management module 314 executes from the OS partition and at step 410, the boot management module 314 reboots the host platform. At step 412, the OS partition 312 (FIG. 3) is presented to the host platform as the primary boot device. In one example, the OS partition 312 is presented as a CDFS formatted device. At step 414, the host platform boots from the OS partition 312 and the operating system on the OS partition is loaded into the host platform.

After the Enterprise operating system is loaded, an application present in the enterprise operating system startup writes a command to unlock Secured partition 320 in a file present in command partition. The device firmware reads that command and unlocks the secured partition so that the user can access the secured partition from the enterprise operating system.

According to an aspect of the invention, the command partition supports communication with the device firmware from the host OS management application 215 on the host platform. Command partition may also receive commands directly from a remote administrative server. The command partition may include data files, which may be written to by these external resources. The data files may be unencrypted and read by the firmware module. Prior to the booting sequence, the command partition functions to switch control to the operating system partition and performs the booting of the enterprise operating system present in the operating system partition. The partitions that are active during the enterprise operating system loading process are the command partition and the operating system partition. The secured partition may be enabled within the enterprise operating system through communication of commands between the command partition and device firmware.

According to an aspect of the invention, a user may be provided with the option to choose among multiple operating systems. An OS management application 313 on the OS partition 312 on the device may support this functionality. This application provides the user with a list of available operating systems, which may be controlled by an administrator according to another aspect of the invention, and receives data indicative of a user operating system selection. The OS management application then identifies the appropriate files to be loaded into the OS partition and loads them. The OS management application also loads the appropriate boot sector on the CDFS format OS partition.

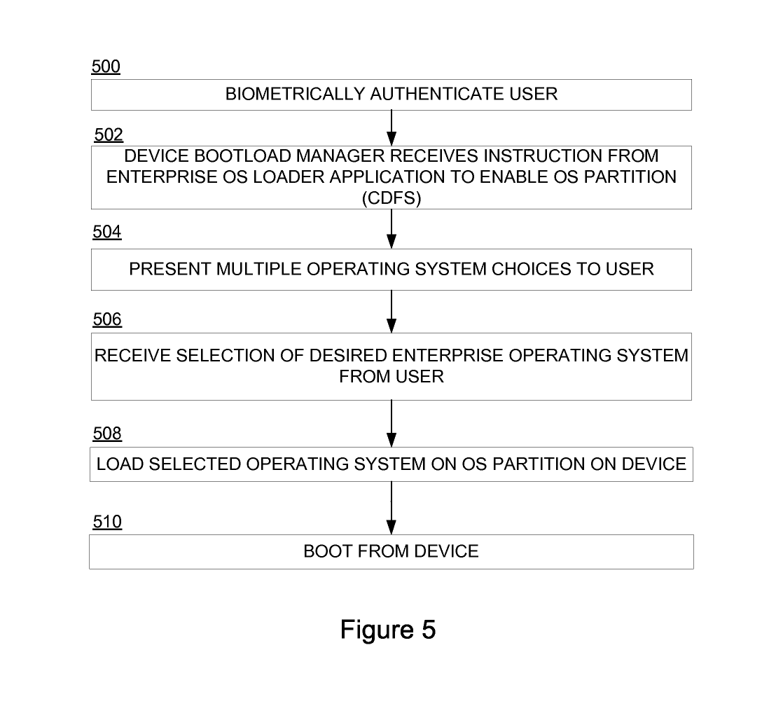

FIG. 5 illustrates a process for selecting among multiple operating systems. At step 500, a user is biometrically authenticated. At step 502, the device boot load manager receives instructions from the device OS management application 313 to enable the OS partition as a CDFS formatted partition. At step 504, the OS management application 313 displays a list of available operating systems to the user. At step 506, data indicative of a selected operating system is received from the user. At step 508, the device OS management application 313 and device boot load manager 336 cooperate to load the selected operating system onto the OS partition. At step 510, the system is rebooted and boots from the OS partition on the device.

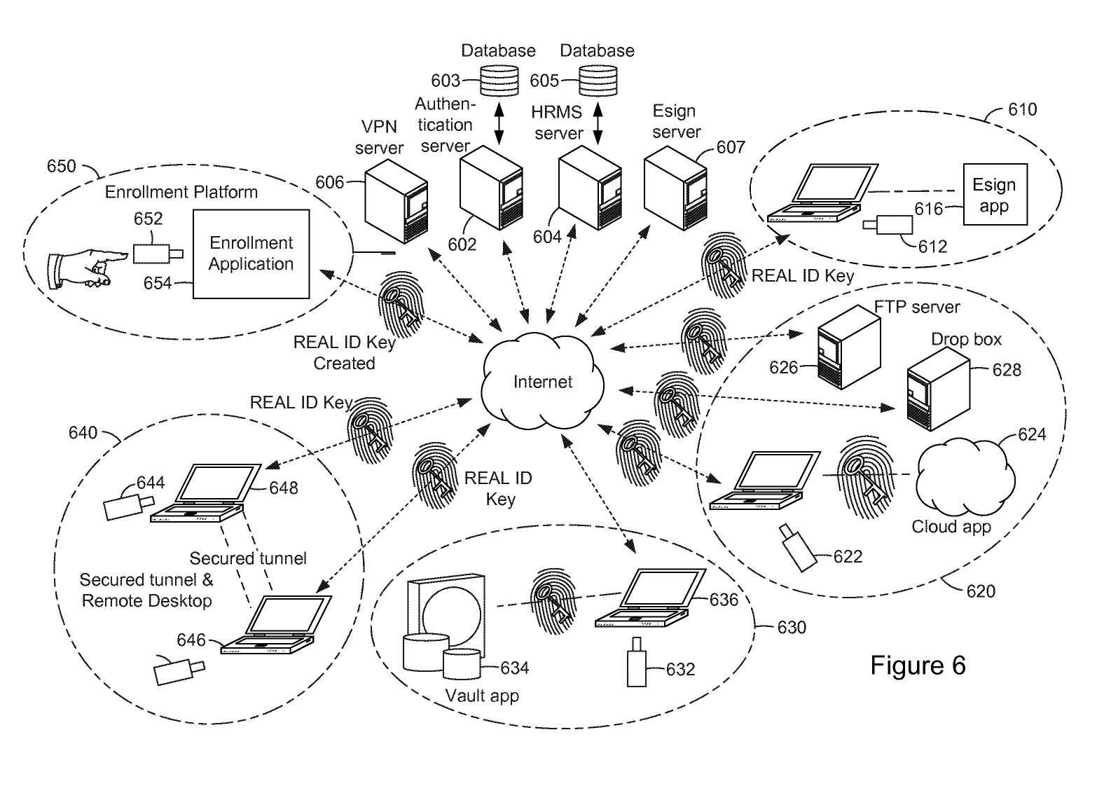

FIG. 6 illustrates a network architecture suitable for supporting one or more real identity authentication devices, processes and systems according to aspects of the invention. Generally, a number of different real identity authentication client environments 610, 620, 630, 640 and 650, each including an associated host computer or platform, and one or more associated applications, may be communicatively coupled to servers 602, 604, 606 and 607 via WAN. Each real identity authentication client environment supports one or more associated real identity authentication device, 612, 622, 632, 642, 644 and 652. A real identity authentication server 602 provides for management of authentication data and support of authentication processes as described above, and may have an authentication database 603, which stores device information, including device identification data, associated biometric tokens, access levels and other data necessary for authenticating and managing the authentication of users. A Virtual Private Network (VPN) server 606 supports hosting of virtual private networks for one or more of the client environments. A Human Resources Management System (HRMS) server 604 and associated database 605 may store human resource information, such as employee profiles, security information, etc. An e-signature or e-sign server 607 may support electronic signatures by users on client platforms executing an associated e-signature or e-sign client application 610. In this example, real identification device 612 is used in conjunction with an e-sign application 610 to ensure that a user making an electronic signature is the true signatory on a document.

Client environment, such as 620, may support cloud computing functionality, with one or more cloud applications 624 being supported by one or more associated servers (not shown). A File Transfer Protocol (FTP) 626 server may be provided for file storage and exchange. A server implementing a file sharing system in a drop box configuration, where users may drag and drop files to folder represented on the client platform, and where the folder is automatically synchronized with a corresponding folder or file storage location on the drop box server 628 such that other users may download or share it, may also be provided. In this case, the real identity authentication device 622 is used to support authentication of users desiring to access cloud applications, files on the FTP server, or files stored on or uploaded to the drop box 628.

Vault application 634 may provide users to save the details of their website login details securely. The user can use their real ID login to register and save the details of the websites like username, password, URL, site name and can add icon to the websites. The saved details are encrypted in device firmware and are stored in the web server. The user must authenticate him to start this vault app which gives list of all the web sites registered by the user. When user clicked on particular site icon he will be automatically redirected to the site and bypasses any additional login process. Since this is real ID login the user can access his secured sites from any system without any additional login process.

Client hosting environment 640 may include a local secured tunnel environment in which client computers 646 and 648 are communicatively linked via secured tunnel. In this example, respective real identity authentication devices 642 and 644 provide for user authentication and access to the secured tunnel communication functionality. Client hosting environment 650 may include an enrollment application 654, which enables a user or administrator to enroll one or more associated real identity authentication devices 652 with the authentication server 602.

According to an aspect of the invention, the real identity authentication devices represented in FIG. 6 may represent use of the same authentication device in different client computing environments or may represent the use of respective different devices in different client computing environments. That is, for example, device 612, 632 and 652 may represent the same real identity authentication device used in different client environments 610, 630 and 650.

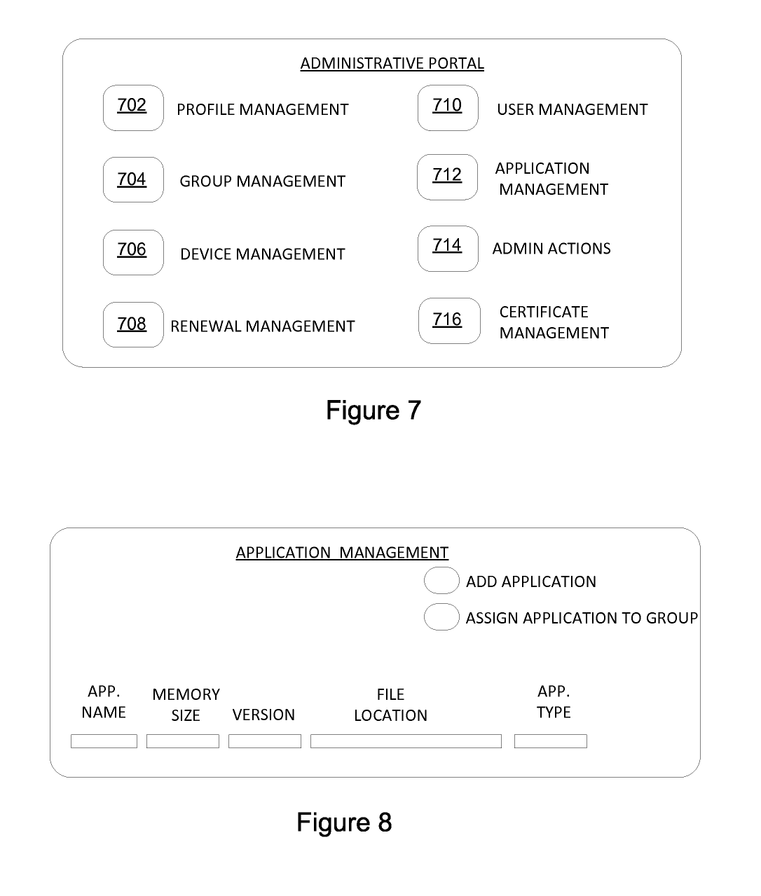

As will be recognized, devices, systems and process according to the invention provide the advantage of allowing real identity authentication devices to be managed in groups, and to associate one or more users, applications, access levels with a given device. In addition, a given user may be associated with more than one real identity authentication device. FIG. 7 illustrates an exemplary user interface for an administrative or policy management portal for managing groups of users, devices and applications, and other functions according to aspects of the invention. An administrator with appropriate rights and credentials may access the administrative control portal through appropriate authentication, including the real identity biometric authentication techniques disclosed in related application Ser. No. 13/645,479. A profile management control 702, which may include an icon that may be clicked on by the user, provides access to functions for creating a new user profile, populating the profile with user information such as name, contact information, and security access levels. A group management control 804 permits creation and management of groups of users.

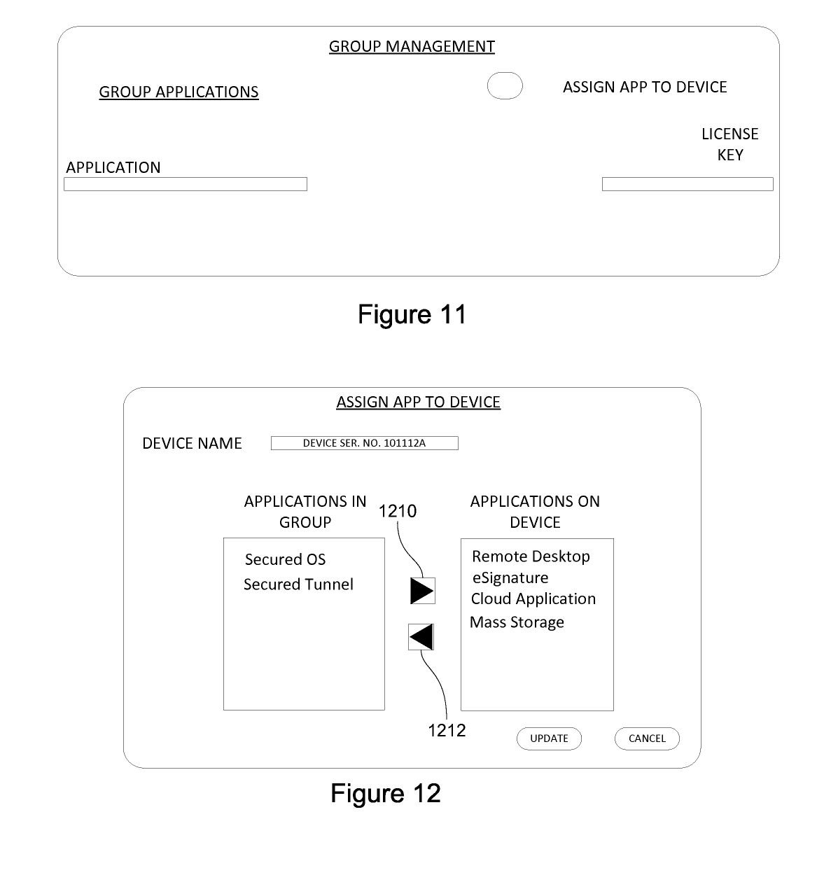

An application management control 712 allows an administrator to access functionality for managing applications, as will be further explained with regard to FIG. 8. A device management control 706 allows an administrator to access functionality for managing devices, as will be further explained with regard to FIGS. 11 and 12. Renewal management control 708 allows management of automated renewals or expiration of access rights for users. User management control 710 allows management of users. Administrative actions control 714 provides access to administrative actions, such as pre-scripted email communications to users and groups based upon administrative actions. Certificate management control 716 provides access to manage digital certificates and it's level of security provided by the manufacturer of the certificate.

FIG. 8 illustrates a user interface screen for facilitating application management functionality according to aspects of the invention. An ADD APPLICATION control permits a user with administrative rights to enter information for a new application to be managed. An ASSIGN APPLICATION TO GROUP control permits a user to assign one or more displayed applications to one or more groups. Fields for APPLICATION NAME, MEMORY SIZE, VERSION, FILE LOCATION and APPLICATION TYPE may display to the user and/or provide the user with the ability to input corresponding data into the system.

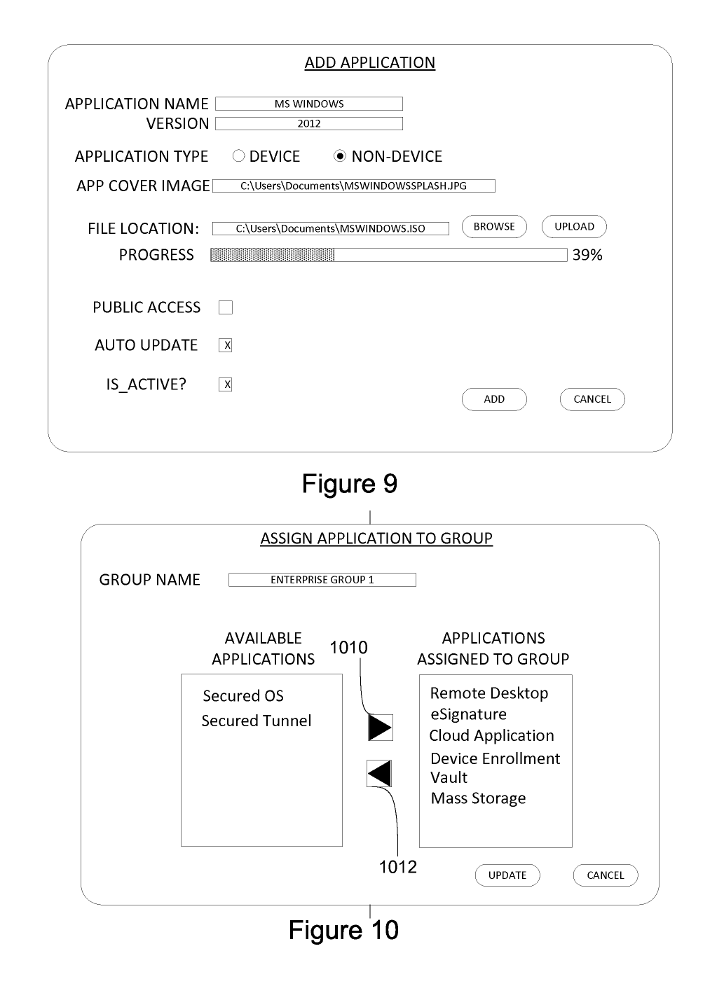

FIG. 9 illustrates a user interface display which may be accessed by activating the ADD APPLICATION control (FIG. 8). The ADD APPLICATION functionality may provide an administrator with the ability to manage applications and operating systems. An APPLICATION NAME may be displayed or entered in an appropriate field. A corresponding VERSION field displays the version of the application. An APPLICATION TYPE field may include radio buttons or other controls to permit a user to specify whether the application type is a device-specific (DEVICE) application or a user-specific (NON-DEVICE) application.

According to an aspect of the invention, a single, portable, secure enterprise platform device may support multiple users. In addition, a single user may be authorized to use more than one portable, secure enterprise platform device. Thus, applications may be assigned to a device or to a user, or both. In FIG. 9, the APPLICATION TYPE is set to be NON-DEVICE, so access to the application will depend upon the particular user using the device. IF DEVICE is selected, then the application will be available through the device, irrespective of who is authorized to use the particular device.

An APPLICATION COVER IMAGE field displays and enables a user to input a file location and name for a cover image graphic, such as a splash screen, to be displayed when the application is launched or operating system is booted. A FILE LOCATION field displays and allows entry of a file location and name for the executable or other file corresponding to the application to be added. In the case of an operating system, the file may be an .iso file. Controls for BROWSE and UPLOAD provide corresponding functionality. A PROGESS indicator may be provided to indicate the progress of file upload.

A check-box control for PUBLIC ACCESS allows a designation for the application to be accessible by the public, or not. An AUTO UPDATE control designates automatic updating for the selected application. An IS_ACTIVE control allows the administrator to mark the application as an active application and disable the application to make it active or inactive. If an application is marked inactive, it will be removed from associated devices upon their next communication session with the server. Similarly, newly active applications will be added to associated devices upon their next communication session with the server.

FIG. 10 illustrates a user interface display for assigning an application to a group. This functionality may be accessed via the ASSIGN APPLICATION TO GROUP control (FIG. 8). A GROUP NAME field displays and allows entry of information representing the name to be given to the group. An AVAILABLE APPLICATIONS field lists all available applications that may be assigned to the indicated group. These may be determined by access rights or other privileges and profiles associated with the indicated group. An APPLICATIONS ASSIGNED TO GROUP field lists all of the application currently assigned to the indicated group. Controls 1010 and 1012 permit a user/administrator to add/remove applications listed in the AVAILABLE APPLICATIONS field to/from the APPLICATIONS ASSIGNED TO GROUP field. An UPDATE control allows for finalizing the assignment of the listed applications to the group.

FIG. 11 illustrates a user interface screen for facilitating group application management functionality according to aspects of the invention. The interface includes fields for APPLICATION NAME and LICENSE KEY. A control for ASSIGN APPLICATION TO DEVICE provides additional interface functions to facilitate assignment of the displayed application to one or more devices.

FIG. 12 illustrates a user interface display for assigning a device to a group. This functionality may be accessed via the ASSIGN APPLICATOIN TO DEVICE control (FIG. 11). A DEVICE NAME field displays and allows entry of uniquely identifying information for a particular device to be assigned. An APPLICATIONS IN GROUP field lists applications or operating systems associated with the group in which the displayed device belongs. An APPLICATIONS ON DEVICE field lists the applications currently on the device identified in the DEVICE NAME field. Controls 1210 and 1212 permit a user/administrator to add/remove applications listed in the APPLICATIONS IN GROUP field to/from the APPLICATIONS ASSIGNED ON DEVICE field. An UPDATE control allows for finalizing the assignment of the listed applications to the device named.

When the Enterprise OS application is executed, a command to unlock the OS partition is written by the enterprise OS management application on a file present in the Command partition. The device firmware reads the command in that file and executes that command and unlocks the OS partition. After the OS partition is unlocked, a success response is written on the file in command partition (322). The enterprise OS management application reads the success status in that file and starts the boot management module.

According to an aspect of the invention the device status and other information can be obtained by writing commands and getting response commands in Command partition (322) files. The device status including the enrollment status (i.e., whether there are any enrolled users or not, and whether the enrollment volume limit is exceeded), as well as data indicative of the device name, the name of the device represented in the NETBIOS of the host system, and the date and time that the device was enrolled by a user can also obtained through commands. An exemplary format may contain an enrollment status indicator, user name information, year, month and date of last login, biometric identification information, access permission information, and associated administrator. The user data is stored in flash memory, which allows true random access.

The above storage scheme permits storage for a number of users within a relatively small memory space. For example, each user's information may be represented in a memory section of 512 bytes of data, such that a 512 Kbyte memory space can contain information on up to 99 users.

It will be recognized that the device and platform management aspects of the invention may apply to the management of licenses, including operating system licenses and application licenses, across an enterprise, and may support improved licensing business models. For example, since the invention provides for applications and operating systems to be managed on a device-specific, user-specific or group-specific basis, In the case of enterprise employees working on a specific project, for example, that may last a number of months, the invention provides for users to select operating systems and applications from a “cafeteria” of such software and administrators may upload (or case the devices assigned to each user to download upon the next connection) the desired operating systems and applications. In this manner, users need not spend as much capital to purchase an unlimited license to a suite of software operating systems and applications, which would only be used for a limited duration. Instead, users pay only for a limited time period and for selected software. As will be recognized, the platform management aspects of the invention may be used to centrally manage licenses and corresponding software associated with each device assigned to a user in an enterprise.

According to another aspect of the invention explained in FIG. 5, the secure boot device may permit a user to select from among a number of operating systems to be securely booted. In this regard, the storage 310 (FIG. 3) may contain multiple operating systems, for example, as .iso image files, which may be stored on the public partition 318. Enterprise operating system management application 215 may provide functionality in which a user is presented with a listing of the operating systems stored on the device 504. The user may then select one of the operating systems and that image 508 copied to the OS partition 312. Upon booting the host platform from the secure boot device, the selected operating system, which now resides on the OS partition, will be booted by the host platform.

It should be understood that implementation of other variations and modifications of the invention in its various aspects may be readily apparent to those of ordinary skill in the art, and that the invention is not limited by the specific embodiments described herein. It is therefore contemplated to cover, by the present invention any and all modifications, variations or equivalents that fall within the spirit and scope of the basic underlying principles disclosed and claimed herein.

What is claimed is:

1. A device for establishing a portable, secure enterprise computing platform, comprising:
a storage, including an operating system partition and a firmware module, a processor for executing instructions stored in the storage;
an interface for communicatively coupling the device with a host platform;
the firmware module including a boot load manager for selectively enabling the host platform to access the operating system partition.

2. The device of claim 1, further comprising an authentication module for biometrically authenticating a user.

3. The device of claim 1, wherein the boot load manager is configured to format the operating system partition as a CDFS device such that the host platform recognizes the device as a bootable CD drive.

4. The device of claim 1, further comprising an operating system partition, wherein the boot load manager includes a flag status table for representing the status of the operating system partition.

5. The device of claim 1, further comprising a public partition and a secure partition, wherein the boot load manager includes a flag status table for representing active or inactive status of the operating system partition, public partition and secure partition.

6. The device of claim 1, wherein the storage further comprises a command partition for receiving commands from an operating system management application executing on the host platform, and wherein the firmware module is configured to receive commands from the command partition.

7. The device of claim 1, wherein the firmware module is configured to receive a command from a remote administrator to upload a new operating system to the operating system partition.

8. The device of claim 6, wherein the command partition is configured to receive encrypted command from an operating system management application executing on the host platform, and wherein the firmware module is configured to decrypt commands from the command partition.

9. The device of claim 1, wherein the boot load manager is configured to load one of a plurality of available operating systems onto the operating system partition in response to user selection of a desired one of the plurality of available operating systems.

10. The device of claim 1, wherein the firmware module is secure against access from the host platform.

11. A process for establishing a portable, secure enterprise platform comprising:
coupling a portable secure enterprise platform device to a host platform, the portable secure enterprise platform device including a storage, including an operating system partition and a firmware module, a processor for executing instructions stored in the storage; an interface for permitting the device to interface with the host platform; an authentication module and a biometric input device;
biometrically authenticating a user with the portable secure enterprise platform device;
executing an enterprise operating system management application on the host platform, the enterprise operating system management application causing a boot load manager to unlock the operating system partition;
executing a boot management module from the operating system partition;
rebooting the host platform in response to commands from the boot management module;
presenting the operating system partition to the host platform as a primary boot device; and
booting the host platform from a secure operating system on the operating system partition.

12. The process of claim 11, wherein the step of presenting the operating system partition includes presenting the operating system partition as a CDFS device such that the host platform recognizes the operating system partition as a bootable CD drive.

13. The process of claim 11, wherein the boot load manager unlocks the operating system partition by modifying a boot load manager table for representing the status of the operating system partition.

14. The process of claim 13, wherein the portable secure enterprise platform device further includes a public partition and a secure partition, wherein the public partition and secure partition may be selectively locked or unlocked by modifying the boot load manager table.

15. The process of claim 1, wherein the storage further comprises a command partition for receiving commands from the enterprise operating system management application executing on the host platform, and wherein the boot load manager unlocks the operating system partition in response to commands received from the command partition.

16. The process of claim 11, further comprising the step of unlocking a secure partition in the storage.

17. The process of claim 11, further comprising the step of presenting a user with list of available operating systems and in response to user selection of one of the listed available operating systems, loading a selected one of the multiple operating systems on the operating system partition.

18. The process of claim 11, further comprising the step of receiving on the device a new operating system in response to a command from a remote administrator.

19. The process of claim 11, further comprising the step of securing the firmware module against access from the host platform.

20. A device for establishing a portable, secure enterprise computing platform, comprising:
a storage, including a firmware module configured for limited access by an administrator, a public partition, an operating system partition, a secure partition and a command partition;
a processor for executing instructions stored in the storage;
an interface for permitting the device to interface with a host platform;
the firmware module including a boot load manager for loading an operating system on the operating system partition and for selectively unlocking at least one of the public partition, the operating system partition, the secure partition, and the command partition, the operating system partition being formatted as a CDFS device such that the host platform recognizes the operating system partition as a bootable CD-ROM drive.
